(19) United States
(12) Patent Application Publication
(10) Pub. No.: US 2003/0188933 A1
(43) Pub. Date: Oct. 9, 2003

(54) Cooling system for axle assembly

(76) Inventors: Michael E. Johnson, Rochester, MI (US); Mark M. Schneider, Royal Oak, MI (US); Larry W. Bowman, Troy, MI (US); Eric B. Ratts, Northville, MI (US); Paul R. Sieber, Rochester Hills, MI (US); Robert W. Hildebrand, Rochester Hills, MI (US); James R. Brichta, Highland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/117,581

(22) Filed: Apr. 5, 2002

(51) Int. Cl. F16D 55/02

(52) U.S. Cl. 188/71.6

(57) ABSTRACT

An axle assembly includes braking components that generate heat during braking applications. The axle assembly includes a housing defining a housing cavity and a rotating component mounted for rotation relative to the housing. A heat dissipation member is mounted along an external surface of the housing. Fluid flow cooperates with the heat dissipation member to cool axle components. The axle assembly preferably includes wet disc brakes having a brake housing defining a brake cavity in fluid communication with the housing cavity. The heat dissipation member preferably includes internal passages in communication with the housing and brake cavities. A pumping mechanism generates fluid flow through the internal passages and through the brake and housing cavities to dissipate heat generated during braking.

### BACKGROUND OF THE INVENTION

This invention generally relates to a method and apparatus for reducing heat in an axle assembly that is generated during braking events.

Braking systems in vehicles are used to reduce the speed of a moving vehicle or to bring the vehicle to a stop. To accomplish these braking events, the braking system generates a braking force to overcome the force of the engine and the inertia of the vehicle. The braking systems typically have one brake assembly mounted at each end of a vehicle axle to provide a braking force at each wheel. Several types of known braking systems are used on vehicles, including, but not limited to, dry disc brakes and wet disc brakes.

During braking events, heat is generated, which can be transferred to other axle components. For vehicles that are subjected to severe duty cycles that include a large number of braking events, the heat generated can be significant. Overheating or prolonged heat exposure for axle components can result in premature wear, which is undesirable.

Thus, it is desirable to provide a method and apparatus for dissipating heat in an axle assembly generated by braking. It would be advantageous for this apparatus to be easily incorporated into existing axle designs with minimal hardware to keep labor and material costs down as well as overcoming the other above-mentioned deficiencies in the prior art.

### SUMMARY OF THE INVENTION

The disclosed axle assembly includes a heat dissipation apparatus to provide cooling to axle components that experience heat generated by vehicle braking operations. The axle assembly includes an axle housing that defines a lateral axis and a rotating component supported for rotation relative to the housing. A braking component is operatively coupled to the rotating component and is movable between braking and non-braking positions. The heat dissipation apparatus is supported on an external surface of the axle housing and extends along the lateral axis for a predetermined length. Fluid cooperates with the heat dissipation apparatus to reduce heat within the axle housing.

In one embodiment, the heat dissipation member include a plurality of fins extending transversely to the axle housing and spaced apart from one another in a lateral direction along the external surface of the axle housing.

In another embodiment, the heat dissipation member includes a plurality of fins extending transversely to the axle housing and spaced apart from one another in a lateral direction along the external surface of the axle housing with each fin having an internal passage that is in fluid communication with an internal housing cavity. A fluid pump, operatively coupled to the rotating component, pumps fluid through the housing cavity and internal passages to cool axle components.

In another embodiment, the heat dissipation member includes a tubing component coiled about the external surface of the axle housing. The tubing component is in fluid communication with an internal axle housing cavity. A fluid pump, operatively coupled to the rotating component, pumps fluid through the housing cavity and tubing component to cool axle components.

Preferably, the axle assembly includes a longitudinally extending input shaft that is coupled to a pair of laterally extending axle shafts that drive the vehicle wheels. Preferably, the braking component comprises a wet disc brake assembly that is mounted to each end of the axle housing. Each wet disc brake assembly includes a brake housing defining a brake cavity, a plurality of rotating discs mounted for rotation with the respective axle shaft, and a plurality of stationary discs mounted to the brake housing and interspersed with the rotating discs in an alternating manner as is known in the art. The brake cavity, housing cavity, and tubing portions of the heat dissipation members are in fluid communication with each other to define a cooling path. A fluid pump pumps fluid through the cooling path to reduce heat in the axle assembly.

Preferably, the fluid pump includes a pump member that is mounted for rotation with at least one rotating axle component. The pump member rotates relative to a stationary pump housing member to generate fluid flow through the axle.

These and other features of the invention may be best understood from the following specification and drawings. The following is a brief description of the drawings.

### BRIEF DESCRIPTION OF THE DRAWINGS

FIG. 1 is a schematic illustration of a system designed according to this invention.

FIG. 2A is input side view of an axle assembly incorporating one embodiment of a heat dissipation member.

FIG. 2B is an enlarged view the heat dissipation member of FIG. 2A.

FIG. 2C is an enlarged cross-sectional view of the heat dissipation member of FIG. 2B incorporating an additional feature.

FIG. 2D is an alternate embodiment of the heat dissipation member of FIG. 2A.

FIG. 3A is an input side view of an axle assembly incorporating an alternate embodiment of a heat dissipation member.

FIG. 3B is an enlarged cross-sectional view of the heat dissipation member of FIG. 3A.

FIG. 4A is top view of a fluid pump as used in axle assembly incorporating the subject invention.

FIG. 4B is a side view of the pump shown in FIG. 4A.

### DETAILED DESCRIPTION OF THE PREFERRED EMBODIMENT

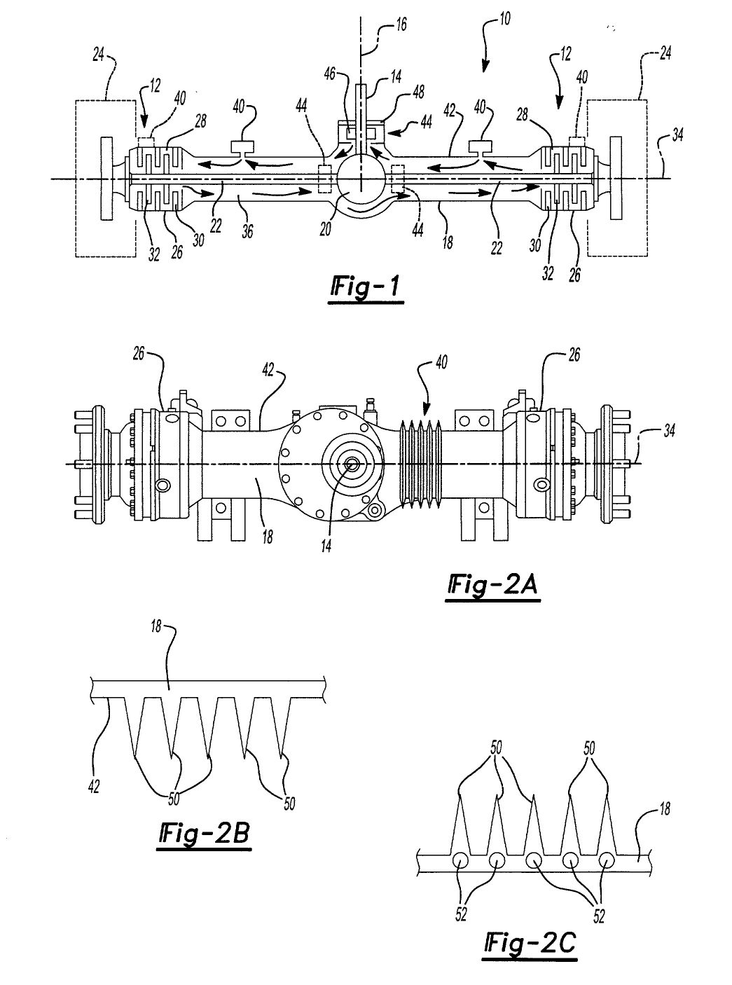

FIG. 1 illustrates an axle assembly 10 with brake assemblies 12 mounted at either end of the axle assembly 10. The axle assembly 10 includes an input shaft 14 defining a longitudinal axis 16 and rotatably supported within an axle housing 18. The input shaft 14 receives driving input from a vehicle engine/transmission (not shown) as is known in the art. The input shaft 14 drives a reduction gear assembly 20 that is operably coupled to a pair of axle shafts 22. The axle shafts 22 in turn drive wheels 24 mounted at either end of the axle housing 18. The wheels 24 are mounted to the axle assembly 10 as is known in the art.

Preferably, the brake assemblies 12 are wet disc brake assemblies that each include a brake housing 26 defining a brake cavity 28 within which a plurality of non-rotating discs 30 are interspersed with a plurality of rotating discs 32 in an alternating manner as is known in the art. The non-rotating discs 30 are mounted to the brake housing 26 and the rotating discs 32 are mounted for rotation with the axle shafts 22 about a lateral axis 34. The discs 30, 32 are immersed in a fluid held in the brake cavity 28. The discs 30, 32 are compressed together during braking to slow/stop rotating of the wheels 24. Any type of fluid known in the art can be used. The operation of wet disc brakes is well known in the art and will not be discussed in detail.

The brake cavity 28 is preferably in fluid communication with a housing cavity 36 formed within the axle housing 18. Fluid is also held within the housing cavity 36 to lubricate axle components, such as the gear assembly 20. A heat dissipation member 40 is mounted to an external surface 42 of the axle housing 18 to reduce heat within the axle assembly 10 that is generated during braking events. In the preferred embodiment, the heat dissipation member is in fluid communication with the housing cavity 36 so that fluid can flow through the brake 28 and housing 36 cavities as well as through the heat dissipation member 40 to cool the axle components. The heat dissipation member 40 can be located on the external surface 42 of the axle housing 18 on both sides of the input shaft 14 or can be located on only one side. Further the heat dissipation member 40 could optionally be mounted on an external surface of the brake housing 26 as an extension of the axle housing 18.

A fluid pump 44 is used to generate the fluid flow through the axle housing 18. The fluid pump 44 includes a rotating member 46 that is coupled to either the input shaft 14 or axle shafts 22 and a housing member 48 that is mounted to a non-rotating axle component, such as the axle housing 18, for example. Rotating of pump member 46 relative to the pump housing member 48 generates fluid flow. A single fluid pump 44 could be used in any of the locations shown in FIG. 1 or a combination of pumps could be used together to increase fluid flow.

The pump 44 generates fluid flow within the axle housing 18 in a linear direction along the lateral axis 34. The pump 44 also preferably generates fluid flow in a circular path about the lateral axis 34 through the heat dissipation members 40. While fluid communication is shown between the brake 28 and housing 36 cavities, it should be understood that either or both of the brake housing 26 and axle housing 18 could be self contained and in respective sole communication with the heat dissipation members. Further, the pump 44 could solely be pumping fluid through the axle housing 18. Thus, various pump 44, cavity 28, 36, and heat dissipation member 40 configurations could be used on an axle assembly 10. The desired combination will depend upon the vehicle application and duty cycle to determine the amount of heat reduction required.

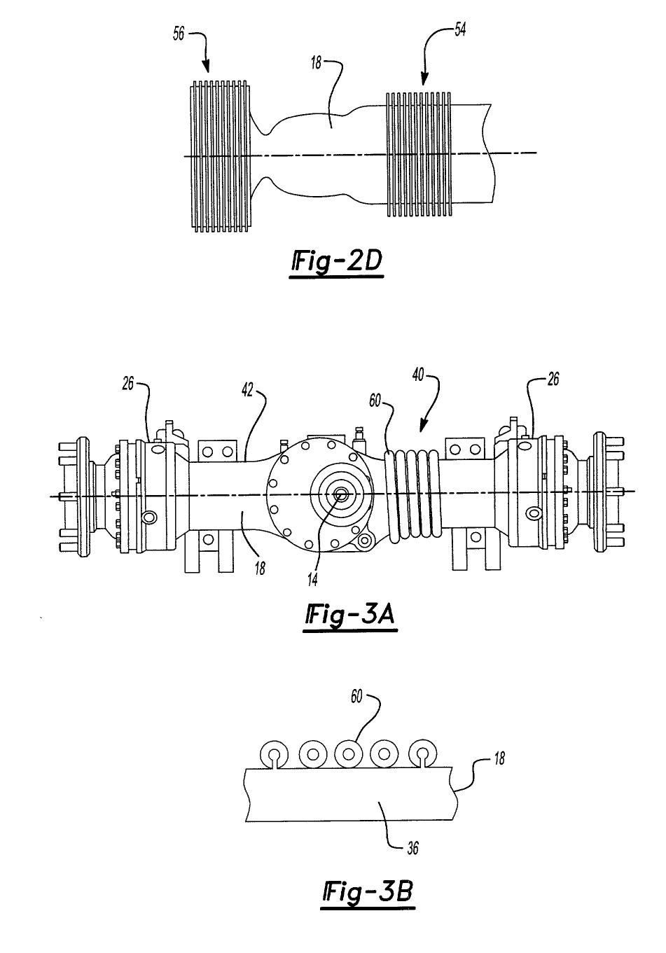

One embodiment of a heat dissipation member 40 is shown in FIGS. 2A and 2B. In this embodiment heat dissipation member 40 includes a plurality of fins 50 that extend transversely relative to the axle housing 18. The fins 50 are spaced apart from one another along the external surface of the housing 18. The fins 50 can be separately attached to the housing 18 or integrally formed as one piece with the housing 18 as shown in FIG. 2B. External air flows over the fins 52 to reduce heat.

As shown in FIG. 2C the fins 50 could include internal tubular portions 52 that are in fluid communication with the axle housing cavity 26. The tubular portions 52 could be connected to each other or kept separate from each other. The pump 44 pumps fluid through the housing cavity 36 and tubular portions 52 to reduce heat. Additionally, external air flows over the fins to further reduce heat.

As shown in FIG. 2D, the fins 50 could include a first set of fins 54 mounted near the center of the axle housing 18 and a second set of fins 56 mounted at the brake housings 26. The first set of fins 54 is preferably longer in length, i.e. the distal edges of the first set of fins 54 extend further away from the axle housing 18, than the distal edges of the second set of fins 56 extend from the brake housing 26. The second set of fins 56 is preferably shorter in length because of clearance issues at the tires.

An alternate embodiment of a heat dissipation member 40 is shown in FIGS. 3A and 3B. In this embodiment, a tubing member 60 is coiled about the external surface 42 of the axle housing 18. The tubing member 60 is coiled for a predetermined length along the axle housing 18. The length can vary depending on the amount of cooling required. The tubing member 60 is in fluid communication with the axle cavity 36 as shown in FIG. 3B. The pump 44 pumps fluid 44 through the tubing member 60 and into the housing cavity 36 to reduce heat.

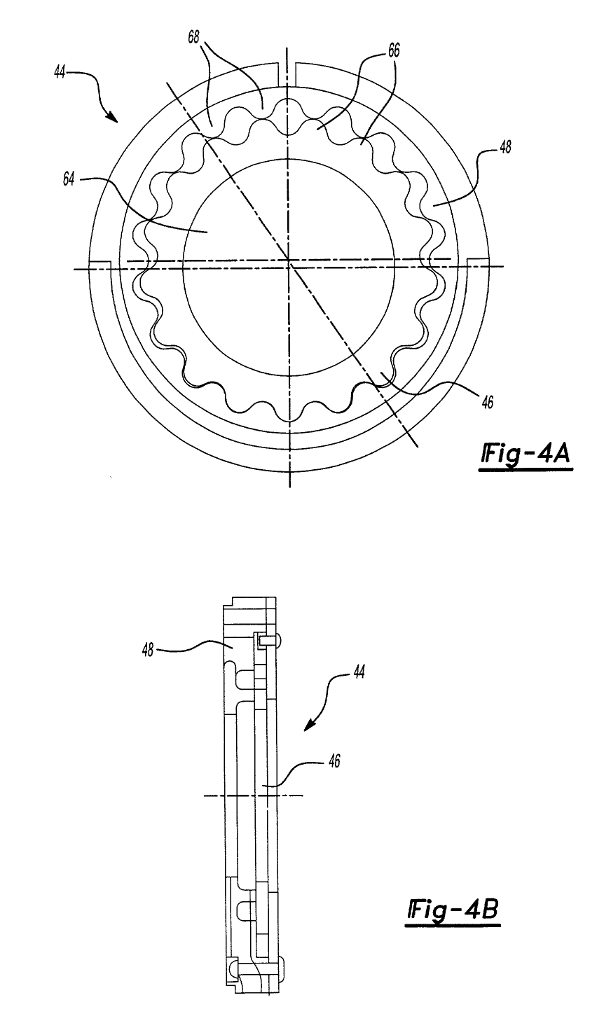

The fluid pump 44 is shown in greater detail in FIGS. 4A and 4B. As discussed above, the fluid pump 44 includes a rotating component 46 and a stationary housing component 48. Preferably the rotating component 46 is mounted to a rotating axle component 64, such as an axle shaft 22 or input shaft 14. The rotating component 46 can be splined, keyed, or similarly attached to the rotating component 64. The housing component 48 is preferably connected to a non-rotating axle component such as the axle housing 18. The rotating component 46 preferably includes a first plurality of gear teeth 66 that mesh with a second plurality of gear teeth 68 on the housing 48. As the teeth 66, 68 mesh, fluid is forced/pumped out, generated fluid flow through the housing 18.

The subject invention provides a method and apparatus for reducing heat in axle components resulting from heat generation during braking events. The subject invention is easily incorporated into existing axle configuration with minimal modifications. The invention has been described in an illustrative manner, and it is to be understood that the terminology that has been used is intended to be in the nature of words of description rather than of limitation. Modifications and variations of the examples described above are possible and it must be understood that such changes may be within the scope of the following claims. In other words, the invention may be practiced otherwise than as specifically described above.

1. An axle assembly comprising:
a housing defining a lateral axis;
a rotating component supported for rotation relative to said housing to drive a pair of laterally spaced wheels;
a braking member operatively coupled to said rotating component and movable between a braking condition where the speed of said rotating component is reduced and a non-braking condition wherein heat within said housing increases as said braking conditions occur over time; and
a heat dissipation member supported by an external surface of said housing, said heat dissipation member extending along said lateral axis for a predetermined length wherein a fluid cooperates with said heat dissipation member to reduce heat within said housing.

2. An assembly as set forth in claim 1 wherein said heat dissipation member comprises a plurality of fins extending transversely relative to said lateral axis and spaced apart from one another along said external surface of said housing and said fluid comprises air that flows over said fins to dissipate heat.

3. An assembly as set forth in claim 2 wherein said plurality of fins comprises a first set of fins mounted near a central portion of said housing and a second set of fins mounted at each lateral end of said housing.

4. An assembly as set forth in claim 3 wherein distal edges of said first set of fins are spaced a greater vertical distance away from said housing than distal edges of said second set of fins.

5. An assembly as set forth in claim 1 including a fluid pump driven by said rotating component wherein said fluid is enclosed within a cavity formed within said housing such that said pump directs fluid through said heat dissipation member to reduce heat.

6. An assembly as set forth in claim 5 wherein said heat dissipation member comprises a tubing member coiled around said external surface of said housing, said tubing member being in fluid communication with said cavity such that said pump directs fluid through said tubing to dissipate heat.

7. An assembly as set forth in claim 5 wherein said heat dissipation member comprises a plurality of fins extending transversely relative to said lateral axis and spaced apart from one another along said external surface of said housing with each of said fins including an internal tubular portion in fluid communication with said cavity such that said pump directs fluid through said tubular portions to dissipate heat.

8. An assembly as set forth in claim 5 wherein said pump includes a first pump member mounted for rotation with said rotating component and a second pump member held stationary relative to said first pump member wherein relative rotation between said first and second pump members generates fluid flow within said cavity.

9. A drive axle assembly comprising:
an axle housing defining an internal housing cavity at least partially filled with a fluid;
a rotating component supported for rotation relative to said axle housing to drive a pair of laterally spaced wheels about a lateral axis of rotation;
a braking member operatively coupled to said rotating component and movable between a braking condition where the speed of said rotating component is reduced and a non-braking condition wherein heat within said axle housing increases during said braking condition;
a heat dissipation member supported by an external surface of said axle housing, said heat dissipation member being in fluid communication with said housing cavity; and
a fluid pump driven by said rotating component to direct said fluid through said heat dissipation member to reduce heat.

10. An assembly as set forth in claim 9 wherein said heat dissipation member extends laterally along said external surface of said axle housing for a predetermined length.

11. An assembly as set forth in claim 10 wherein said fluid pump includes a first pump member mounted for rotation with said rotating component and a second pump member held stationary relative to said first pump member wherein relative rotation between said first and second pump members generates fluid flow within said housing cavity.

12. An assembly as set forth in claim 11 wherein said rotating component includes an input shaft operatively coupled to a pair of laterally extending axle shafts that are operatively coupled to drive said wheels.

13. An assembly as set forth in claim 12 wherein said first pump member is connected to said input shaft and said second pump member comprises a pump housing supported by said axle housing.

14. An assembly as set forth in claim 12 wherein said first pump member is connected to at least one of said axle shafts and said second pump member comprises a pump housing supported by said axle housing.

15. An assembly as set forth in claim 12 wherein said braking member comprises a first wet disc brake assembly coupled to one of said axle shafts and a second wet disc brake assembly coupled to the other of said axle shafts.

16. An assembly as set forth in claim 15 wherein each of said first and second wet disc brake assemblies includes a brake housing defining a brake cavity in fluid communication with said housing cavity, a plurality of stationary discs mounted to said brake housing and a plurality of rotating discs mounted for rotation with said respective axle shaft and wherein said pump directs flow through a cooling path that extends through said housing cavity, through said brake cavity, and through said heat dissipation member.

17. An assembly as set forth in claim 16 wherein said heat dissipation member comprises a tubing member coiled around said external surface of said axle housing, said tubing member being in fluid communication with at least one of said housing or brake cavities such that said pump directs fluid through said tubing to dissipate heat.

18. An assembly as set forth in claim 16 wherein said heat dissipation member comprises a plurality of fins spaced apart from one another along said external surface of said housing with each of said fins including an internal tubular portion in fluid communication with at least one of said brake or housing cavities such that said pump directs fluid through said tubular portions to dissipate heat.

19. An assembly as set forth in claim 9 wherein said fluid pump generates fluid flow in a linear path through said housing cavity along said lateral axis of rotation and generates fluid flow in a circular path directed about said lateral axis of rotation.

20. A method for cooling an axle assembly comprising the steps of:
(a) providing an axle housing having an internal cavity, a rotating component supported for rotation relative to the axle housing, and a braking component operatively coupled to the rotating component;
(b) mounting a heat dissipation member to an external surface of the axle housing to extend in a lateral direction along a predetermined length of the axle housing; and
(c) generating fluid flow for interaction with the heat dissipation member to reduce heat generated when the braking component is activated.

21. A method as set forth in claim 20 wherein the heat dissipation member comprises a plurality of fins and step (b) further includes mounting the plurality of fins along the external surface of the axle housing with each fin extending transversely relative to the axle housing and being spaced apart from the next by a predetermined distance; and step (c) further includes generating air flow to flow over the fins to dissipate heat.

22. A method as set forth in claim 21 wherein the plurality of fins comprises a first set of fins and a second set of fins and wherein step (b) further includes mounting the first set of fins near a central portion of the axle housing and the second set of fins at each end of the axle housing with the second set of fins having a shorter length than the first set of fins.

23. A method as set forth in claim 20 wherein step (a) further includes providing a fluid pump driven by the rotating component wherein the fluid is enclosed within a housing cavity formed within the axle housing; step (b) further includes providing fluid communication between the housing cavity and the heat dissipation member; and step (c) further includes pumping the fluid through the heat dissipation member and housing cavity to reduce heat.

24. A method as set forth in claim 23 wherein the heat dissipation member comprises a tubing member and step (b) further includes coiling the tubing member around the external surface of the axle housing and fluidly connecting the tubing member and the housing cavity; and step (c) includes pumping fluid through the tubing and housing cavity to dissipate heat.

25. A method as set forth in claim 24 wherein the braking component comprises wet disc brake assemblies operatively coupled to the rotating component at either end of the axle housing with each wet disc brake assembly having a brake housing defining a brake cavity, a plurality of stationary discs mounted to the brake housing, and a plurality of rotating discs mounted for rotation with the rotating component and wherein step (c) further includes fluidly connecting the housing cavity with the brake cavity to define a cooling path that extends through the housing cavity, through the brake cavity, and through the tubing member, and pumping fluid through the cooling path to dissipate heat generated during activation of the wet disc brake assemblies.

26. A method as set forth in claim 23 wherein the heat dissipation member comprises a plurality of fins and step (b) further includes spacing each fin apart from one another along the external surface of the axle housing with each of the fins including an internal tubular portion in fluid communication with the housing cavity; and step (c) further includes pumping fluid through the tubular portions and housing cavity to dissipate heat.

27. A method as set forth in claim 26 wherein the braking component comprises wet disc brake assemblies operatively coupled to the rotating component at either end of the axle housing with each wet disc brake assembly having a brake housing defining a brake cavity, a plurality of stationary discs mounted to the brake housing, and a plurality of rotating discs mounted for rotation with the rotating component and wherein step (c) further includes fluidly connecting the housing cavity with the brake cavity to define a cooling path that extends through the housing cavity, through the brake cavity, and through the tubular portions, and pumping fluid through the cooling path to dissipate heat generated during activation of the wet disc brake assemblies.

28. A method as set forth in claim 23 wherein step (c) further includes pumping fluid along a lateral axis in a generally linear path inside the axle housing and pumping fluid in a generally circular path about the lateral axis external to the axle housing.

29. A method as set forth in claim 28 wherein the rotating component includes an input shaft operatively coupled to a pair of laterally extending axle shafts and wherein step (c) further includes connecting a first pump member to at least one of the input and axle shafts, connecting a second pump member to a non-rotating axle component, and generating fluid flow in the axle housing and heat dissipation member by rotating the first pump member relative to the second pump member.

30. A method as set forth in claim 29 wherein the braking component comprises wet disc brake assemblies operatively coupled to the axle shafts at either end of the axle housing with each wet disc brake assembly having a brake housing defining a brake cavity, a plurality of stationary discs mounted to the brake housing, and a plurality of rotating discs mounted for rotation with the respective axle shafts and wherein step (c) further includes fluidly connecting the housing cavity with the brake cavity to define a cooling path that extends through the housing cavity, through the brake cavity, and through the heat dissipation member, and pumping fluid through the cooling path to dissipate heat generated during activation of the wet disc brake assemblies.
